(19) United States
(12) Patent Application Publication
(10) Pub. No.: US 2026/0197098 A1
(43) Pub. Date: Jul. 9, 2026

(54) METHOD FOR CALIBRATING THE TRANSMISSION OF PHASED ARRAY ANTENNA WITH BUILT-IN LOCAL OSCILLATOR AND ELECTRONIC DEVICE

(71) Applicant: JCET Management Co., LTD., Shanghai (CN)

(72) Inventors: Wei LIN, Shanghai (CN); Yanbo TANG, Shanghai (CN); Cheng YANG, Shanghai (CN); Boping WU, Shanghai (CN)

(73) Assignee: JCET Management Co., LTD., Shanghai (CN)

(21) Appl. No.: 19/442,520

(22) Filed: Jan. 7, 2026

(30) Foreign Application Priority Data
Jan. 8, 2025 (CN) 202510029884.1

(51) Int. Cl. H04B 17/12; H01Q 3/26; H04B 17/13; H04B 17/21

(52) U.S. Cl. CPC H04B 17/12; H01Q 3/267; H04B 17/13; H04B 17/221

(57) ABSTRACT

A method for calibrating the transmission of a phased array antenna with a built-in local oscillator and an electronic device are provided. The method includes: constructing and configuring a test system, where a receiving antenna is located on a central axis of the phased array antenna; dividing the phased array antenna according to a layout of the phased array antenna, where the layout of the phased array antenna is divided into centrally symmetric ring areas, and each of the ring areas includes one or more centrally symmetric sub-units, and each of the sub-units includes a same number of antenna channels; and transmitting signals using the phased array antenna and receiving signals by the receiving antenna, and performing amplitude and phase calibration between the antenna channels within the sub-units of the ring areas, between the sub-units of the ring areas, and between the ring areas.

### CROSS-REFERENCE TO RELATED APPLICATIONS

This application claims the benefit of priority to Chinese Application No. 202510029884.1, filed Jan. 8, 2025, which is incorporated herein by reference in its entirety.

### TECHNICAL FIELD

The present application relates to the field of phased array antenna technology, and specifically relates to a method for calibrating the transmission of a phased array antenna with a built-in local oscillator and an electronic device.

### BACKGROUND

The phased array antenna generates controllable beams by adjusting the phase and amplitude of each array unit. Compared to mechanical scanning, phased array antenna not only improves scanning speed and flexibility but also can generate a plurality of beams, and therefore, it has been widely used in a plurality of fields such as radar, satellite communication, and wireless communication, etc. However, as the integration levels of large-scale phased array antenna increase, the problems of phase and amplitude errors become increasingly prominent, which will result in radiation pattern distortion and system performance degradation. Therefore, precise phase and amplitude calibration are particularly important.

### SUMMARY

The present disclosure provides a method for calibrating the transmission of a phased array antenna with a built-in local oscillator and an electronic device.

The present disclosure is achieved through the following technical solution.

The embodiments of the disclosure provide a method for calibrating the transmission of a phased array antenna with a built-in local oscillator, which includes the following steps: constructing and configuring a test system, a receiving antenna is located on the central axis of a phased array antenna, and the receiving antenna is connected with a spectrum analyzer; dividing the phased array antenna according to its layout, which is divided into a plurality of centrally symmetric ring areas according to the central axis of the phased array antenna, and each ring area has one or more centrally symmetric sub-units, and each sub-unit includes a plurality of antenna channels of the same number; and transmitting signals using the phased array antenna and receiving signals by the receiving antenna, and performing amplitude and phase calibration between antenna channels within sub-units of the ring areas, between sub-units of the ring areas, and between different ring areas, to achieve the calibration for the transmission of the entire phased array antenna.

In some implementations, the test system includes a phased array antenna, a receiving antenna, a spectrum analyzer, and a control computer, and the receiving antenna is connected with the spectrum analyzer, and one end of the control computer is connected with the phased array antenna for configuring and controlling different antenna channels of the phased array antenna to transmit signals, and another end of the control computer is connected with the spectrum analyzer, and the corresponding amplitude and phase signals of the receiving antenna are obtained using the spectrum analyzer.

In some implementations, the ring areas have a plurality of centrally symmetric sub-units, and the sub-units specifically include corner units, x-axis mirror units, and y-axis mirror units, and the corner units are a plurality of antenna channels located at the four corners of the ring areas, and the x-axis mirror units are a plurality of antenna channels located in the x-axis direction and centrally symmetric in the ring areas, and the y-axis mirror units are a plurality of antenna channels located in the y-axis direction and centrally symmetric in the ring areas.

In some implementations, in the method, a first calibration is performed within the corner units, within the x-axis mirror units, and within the y-axis mirror units, respectively, to obtain first amplitude control values and first phase control values for the corresponding antenna channels; a second calibration is performed between sub-units of the same ring area to obtain second amplitude control values and second phase control values for the corresponding antenna channels; a third calibration is performed between different ring areas to obtain third amplitude control values and third phase control values for the corresponding antenna channels; the first amplitude control values, the second amplitude control values, and the third amplitude control values are summed to obtain final amplitude control values, and the first phase control values, the second phase control values, and the third phase control values are summed to obtain final phase control values, and thus the calibration for the transmission of the entire phased array antenna is achieved.

In some implementations, in the method, when performing the first calibration within the corner units, the method includes the following steps: opening a first corner antenna channel, closing other antenna channels, setting a specific power attenuation, transmitting signals and measuring the first corner power P1 of the receiving antenna; opening a second corner antenna channel, closing other antenna channels, transmitting signals and adjusting the attenuation until the second corner power of the receiving antenna equals P1, and obtaining the first amplitude control value of the corresponding second corner antenna channel; opening the first corner antenna channel and the second corner antenna channel and closing other antenna channels, fixing the phase of the first corner antenna channel and adjusting the phase of the second corner antenna channel, recording the corresponding first phase control values of the two antenna channels when power is maximum to complete the first calibration of the second corner antenna channel; and opening in sequence the first corner antenna channel and other corner antenna channels within the corner units simultaneously, repeating the above steps to complete the first calibration for other corner antenna channels.

In some implementations, in the method, when performing the first calibration within the x-axis mirror units, the method includes the following steps: opening a first x-axis antenna channel, closing other antenna channels, setting a specific power attenuation, transmitting signals and measuring the first x-axis power P2 of the receiving antenna; opening a second x-axis antenna channel, closing other antenna channels, transmitting signals and adjusting the attenuation until the second x-axis power of the receiving antenna equals P2, and obtaining the first amplitude control value of the corresponding second x-axis antenna channel; opening the first x-axis antenna channel and the second x-axis antenna channel and closing other antenna channels, fixing the phase of the first x-axis antenna channel and adjusting the phase of the second x-axis antenna channel, recording the first phase control values of the two antenna channels when power is maximum to complete the first calibration of the second x-axis antenna channel; and opening in sequence the first x-axis antenna channel and other x-axis antenna channels within the x-axis mirror units simultaneously, repeating the above steps to complete the first calibration for other x-axis antenna channels.

In some implementations, in the method, when performing the first calibration within the y-axis mirror units, the method includes the following steps: opening a first y-axis antenna channel, closing other antenna channels, setting a specific power attenuation, transmitting signals and measuring the first y-axis power P3 of the receiving antenna; opening a second y-axis antenna channel, closing other antenna channels, transmitting signals and adjusting the attenuation until the second y-axis power of the receiving antenna equals P3, and obtaining the first amplitude control value of the corresponding second y-axis antenna channel; opening the first y-axis antenna channel and the second y-axis antenna channel and closing other antenna channels, fixing the phase of the first y-axis antenna channel and adjusting the phase of the second y-axis antenna channel, recording the first phase control values of the two antenna channels when power is maximum to complete the first calibration of the second y-axis antenna channel; and opening in sequence the first y-axis antenna channel and other y-axis antenna channels within the y-axis mirror units simultaneously, repeating the above steps to complete the first calibration for other y-axis antenna channels.

In some implementations, in the method, when performing the second calibration between sub-units of the same ring area, the method includes the following steps: opening all corresponding antenna channels of a sub-unit after calibration of the same ring area, closing other antenna channels, transmitting signals and measuring the sub-unit power P5 of the receiving antenna using a spectrum analyzer; closing all corresponding antenna channels of a sub-unit of the same ring area, opening all corresponding antenna channels of any one of other sub-units after calibration; synchronously controlling the amplitude attenuation of all corresponding antenna channels until the measured value of the spectrum analyzer is a₁*P5, factor

$${α}_{1} = \frac{{D}^{2} + {d}_{2}^{2}}{{D}^{2} + {d}_{1}^{2}} ,$$

and D is the distance from the receiving antenna to the phase center of the phased array antenna, and d₂ is the distance from the phase center of the other sub-units to the phase center of the phased array antenna; d₁ is the distance from the phase center of a sub-unit of the same ring area to the phase center of the phased array antenna, and obtaining the corresponding second amplitude control value; synchronously opening all corresponding antenna channels of the above sub-unit after amplitude calibration, maintaining the amplitudes and phases of all antenna channels of one of the sub-units unchanged, synchronously transforming the phases of all antenna channels in another sub-unit, recording the second phase control value of another sub-unit when power is maximum to complete calibration for another sub-unit of the same ring area; and opening in sequence all corresponding antenna channels of one sub-unit of the same ring area and all corresponding antenna channels of another sub-unit of the same ring area simultaneously, repeating the above steps to complete the second calibration for all sub-units of the same ring area.

In some implementations, in the method, when performing the third calibration between different ring areas, the method includes the following steps: opening all antenna channels of a sub-unit of the first ring area after calibration, closing other antenna channels, transmitting signals and measuring the power P6 of a sub-unit of the first ring area obtained by the receiving antenna using a spectrum analyzer; closing all antenna channels of a sub-unit of the first ring area, opening all antenna channels of a sub-unit of different ring areas after calibration; synchronously control the amplitude attenuation of all corresponding antenna channels until the measured value of the spectrum analyzer is a₃*P6, factor

$${α}_{3} = \frac{{D}^{2} + {d}_{4}^{2}}{{D}^{2} + {d}_{1}^{2}} ,$$

and D is the distance from the receiving antenna to the phase center of the phased array antenna, and d₄ is the distance from the phase center of the corresponding sub-unit of the corresponding different ring areas to the phase center of the phased array antenna; d₁ is the distance from the phase center of the corresponding sub-unit in the first ring area to the phase center of the phased array antenna, and obtaining the third amplitude control value of a sub-unit in the corresponding different ring areas; synchronously opening all the above antenna channels after amplitude calibration, maintaining the amplitudes and phases of all antenna channels of a sub-unit of the first ring area unchanged, synchronously transforming the phases of all antenna channels of a sub-unit of different ring areas, recording the third phase control value of a sub-unit in the corresponding different ring areas when power is maximum to complete the third calibration for corresponding different ring areas; and opening in sequence all corresponding antenna channels of a sub-unit of the first ring area and all corresponding antenna channels of a sub-unit of other ring areas simultaneously, repeating the above steps to complete the third calibration for all ring areas.

In some implementations, the phase center of each centrally symmetric sub-unit coincides with the physical center of the phased array antenna.

In some implementations, the method further includes: using a multi-frequency point calibration method to perform multiple calibrations at different frequency points.

The present disclosure further provides an electronic device, which includes a processor, a memory, and a computer program stored in the memory and configured to be executed by the processor, and the memory is coupled with the processor, and when the processor executes the computer program, it carries out the above described method for calibrating the transmission of a phased array antenna with a built-in local oscillator.

### BRIEF DESCRIPTION OF THE DRAWINGS

In order to illustrate the technical solutions in the embodiments of the present disclosure or the related art, a brief introduction will be given below to the accompanying drawings required for the description of the embodiments or the related art, and it is obvious that the accompanying drawings described below are merely some embodiments of the present disclosure, and for those skilled in the art, other accompanying drawings can also be obtained according to these drawings without inventive effort.

FIG. 1 is a structural principle schematic diagram for constructing the test system according to the present disclosure;

FIG. 2 is a structural schematic diagram of the phased array antenna divided according to its layout according to an embodiment of the present disclosure;

FIG. 3 is a schematic diagram showing the amplitude of the synthesized signal, the amplitude of which exhibits periodic change with phase difference, resulted from the superposition of signals of the same frequency according to an embodiment of the present disclosure;

FIG. 4 is a principle schematic diagram of calibrating the corresponding antenna channels of the corner units within the second ring area according to an embodiment of the present disclosure;

FIG. 5 is a principle schematic diagram of calibrating the corresponding antenna channels of the x-axis mirror units within the second ring area according to an embodiment of the present disclosure;

FIG. 6 is a principle schematic diagram of calibrating the corresponding antenna channels of the y-axis mirror units within the second ring area according to an embodiment of the present disclosure; and

FIG. 7 is a principle schematic diagram of calibrating the corresponding antenna channels of the corner units within the first ring area according to an embodiment of the present disclosure.

### DETAILED DESCRIPTION

In order to make the objects, technical solutions, and advantages of the embodiments of the present disclosure clearer, the technical solutions in the embodiments of the present disclosure will be described below in conjunction with the accompanying drawings of the embodiments of the present disclosure. The described embodiments are merely a part of embodiments of the present disclosure, not all embodiments. Based on the embodiments of the present disclosure, all other embodiments obtained by those skilled in the art without inventive effort are within the protection scope of the present disclosure.

The phased array antenna generates controllable beams by adjusting the phase and amplitude of each array unit. Compared to mechanical scanning, phased array antenna not only improves scanning speed and flexibility but also can generate a plurality of beams, and therefore, it has been widely used in a plurality of fields such as radar, satellite communication, and wireless communication, etc. However, as the integration levels of large-scale phased array antenna increase, the problems of phase and amplitude errors become increasingly prominent, which will result in radiation pattern distortion and system performance degradation. Therefore, precise phase and amplitude calibration is particularly important.

With the increasing demand for high integration and miniaturization applications, the application of AIP (Antenna in Package) technology has become increasingly widespread. Constrained by space limitations, AIP typically does not reserve ports for phased array amplitude and phase testing. To further improve integration level and reduce costs, many solutions have adopted built-in local oscillator technology. However, there is a frequency deviation and random jitter between the built-in local oscillator and instrument signals, and this frequency deviation can be reduced using higher-specification components and more optimized circuit designs.

The vector network analyzer is a commonly used device for measuring antenna parameters, and its testing principle is to measure the S-parameters of the link and process the data to obtain various antenna parameters. In vector network measurements, in order to ensure the dynamic range of the test, the intermediate frequency bandwidth needs to be set to a small range, such as 1 KHz. At this time, the difference between the output frequency (e.g., port 1 output) and the receive frequency (e.g., port 2 input) of the vector network analyzer needs to be remained within the 1 KHz range of the intermediate frequency bandwidth, and signals exceeding this range will be filtered out. When testing phased array antenna without a built-in local oscillator, since both the output and input frequencies are generated by the vector network, there is no frequency difference, and the testing can be proceeded smoothly.

However, when testing the phased array antenna with a built-in local oscillator, the output frequency of the built-in phased array antenna needs to be configured to be the output frequency of the vector network, and the vector network will then receive at the receiving frequency. But when the phased array to be tested uses a built-in local oscillator, since the crystal oscillator is not shared with the vector network, there is a significant frequency deviation between the output frequency of the phased array antenna and the output frequency of the vector network, even if the target frequency values of the two configurations are the same. This deviation typically exceeds the intermediate frequency bandwidth range.

Additionally, in order to maintain cost-effectiveness, high specification crystal oscillators similar to those used in measuring instruments are usually not used for the built-in local oscillator of phased array antennas. This results in significant frequency jitter over time, which in turn increases the instability of frequency deviation and further widens the deviation. In this case, the reception function of the vector network analyzer will not be able to be implemented, resulting in the entire test process being unable to proceed. Therefore, there is an urgent need to develop a transmission calibration method for phased array antennas with a built-in local oscillator.

The beneficial effects of the present disclosure include the following.

In the present disclosure, by dividing the phased array antenna into a plurality of different sub-units according to its layout, and positioning the receiving antenna on the central axis of the phased array antenna, and by performing amplitude and phase calibration within sub-units of the ring areas, between sub-units of the ring areas, and between different ring areas, the calibration for the transmission of the entire phased array antenna is achieved. When executing the calibration procedure, the receiving antenna does not need to perform any movement operations. Since the logical basis of the calibration process is to ensure that the antenna units at geometrically symmetric positions have zero phase difference in their path when receiving signals. This means that when signals arrive at the receiving antenna unit from different antenna channels of the phased array antenna, their arrival times are consistent, thereby ensuring phase consistency. Additionally, the phase centers of each geometrically symmetric sub-unit should coincide with the physical center of the entire phased array antenna. This design may ensure that the propagation paths and phase differences of the signals in each sub-unit are precisely controlled and coordinated, so that the performance of the entire antenna system is optimized. This design significantly improves the efficiency of calibration operations, making the entire process more efficient and convenient, particularly for phased array systems that integrate local oscillators.

The present disclosure effectively solves a core problem in the traditional vector network analyzer (vector network) test system, i.e., the signal synchronization problem, and benefit from the phased array antenna calibration method described above, a first calibration is performed within the corner units, within the x-axis mirror units, and within the y-axis mirror units, respectively, to obtain first amplitude control values and first phase control values for the corresponding antenna channels; a second calibration is performed between sub-units of the same ring area to obtain second amplitude control values and second phase control values for the corresponding antenna channels; a third calibration is performed between different ring areas to obtain third amplitude control values and third phase control values for the corresponding antenna channels; the first amplitude control values, the second amplitude control values, and the third amplitude control values are summed to obtain final amplitude control values, and the first phase control values, the second phase control values, and the third phase control values are summed to obtain final phase control values, and thus the calibration for the transmission of the entire phased array antenna is achieved. The calibration technology of the present disclosure is not only applicable to phased array systems with integrated local oscillators, but also can be widely used for calibration operations of various highly integrated active phased array radars (AIP phased arrays). Therefore, the present disclosure has broad application prospects and practical application value in the field of radar system calibration.

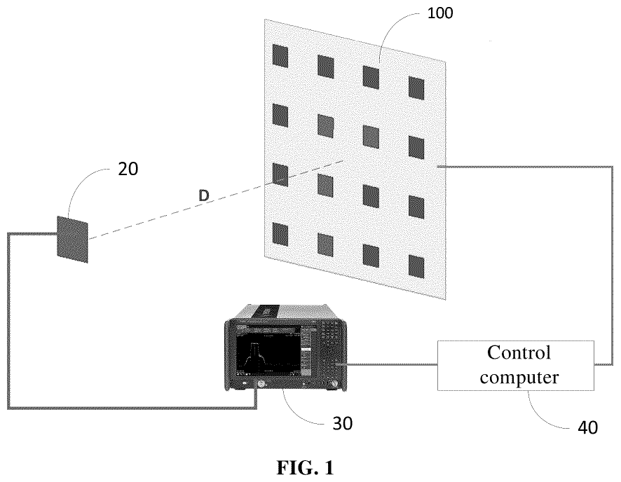

In the implementation of the present disclosure, referring to FIG. 1, the test system includes a phased array antenna 100, a receiving antenna 20, a spectrum analyzer 30 for acquiring signals, and a control computer 40, and in the transmission calibration method, the receiving antenna 20 is connected with the spectrum analyzer 30, and one end of the control computer 40 is connected with the phased array antenna 100 for configuring and controlling the transmission of signals from different antenna channels of the phased array antenna 100, and another end of the control computer 40 is connected with the spectrum analyzer 30 to acquire corresponding amplitude and phase signals of the receiving antenna 20 using the spectrum analyzer 30.

The embodiments of the disclosure first provide a method for calibrating the transmission of a phased array antenna with a built-in local oscillator, the method includes the following steps: constructing and configuring a test system, a receiving antenna is located on the central axis of a phased array antenna, and the receiving antenna is connected with a spectrum analyzer; dividing the phased array antenna according to its layout, which is divided into a plurality of centrally symmetric ring areas according to the central axis of the phased array antenna, and each ring area has one or more centrally symmetric sub-units, and each sub-unit includes a plurality of antenna channels of the same number; and transmitting signals using the phased array antenna and receiving signals by the receiving antenna, and performing amplitude and phase calibration between antenna channels within sub-units of the ring areas, between sub-units of the ring areas, and between different ring areas, to achieve the calibration for the transmission of the entire phased array antenna.

In some implementations, the test system is constructed and configured, the receiving antenna 20 is located on the central axis of the phased array antenna 100, and the receiving antenna 20 is connected with the spectrum analyzer 30, according to the adjusted signals and jitter parameters emitted by the phased array antenna, the phased array antenna 100 is used to transmit signals, and the receiving antenna 20 is used to receive signals, and the amplitude and phase calibrations are performed between antenna channels within sub-units of the ring areas, between sub-units of the ring areas, and between different ring areas, to achieve the calibration for the transmission of the entire phased array antenna.

The phased array antenna is divided according to its layout, and is divided into a plurality of centrally symmetric ring areas according to the central axis of the phased array antenna, and each ring area has one or more centrally symmetric sub-units, and each sub-unit includes a plurality of antenna channels of the same number.

The phased array antenna is used to transmit signals, and the amplitude and phase calibrations are performed within sub-units of the ring areas, between sub-units of the ring areas, and between different ring areas, to achieve the calibration for the transmission of the entire phased array antenna.

In the present implementation, during the process of constructing and configuring the test system, the receiving antenna 20 needs to be precisely arranged on the central axis of the phased array antenna 100. Moreover, the receiving antenna 20 needs to be arranged at a far-field working distance of the phased array antenna 100, because the far-field working distance can provide a uniform plane wave, so that the accuracy and consistency of test data are ensured.

In order to ensure that the performance of phased array antenna 100 meets expectations, we need to perform frequency detection on it using the spectrum analyzer 30. In some implementations, the spectrum analyzer 30 is used to precisely measure the response characteristics of the phased array antenna 100 at different frequencies. Before performing frequency detection, we also need to adjust the bandwidth and power measurement parameters of the spectrum analyzer to ensure the accuracy and reliability of the measurement results. When the phased array antenna is connected to the control computer and appropriate transmission parameters such as frequency, power, and modulation mode are set, the phased array antenna is activated, a part of the antenna channels of the phased array antenna are made to begin transmitting signals. At this time, the spectrum analyzer will receive signals from the receiving antenna and perform real-time analysis on them.

Wherein in the present embodiment, according to the signal characteristics and jitter parameters of the phased array antenna 100, the settings of frequency range for the spectrum analyzer are adjusted to the maximum signal capture mode, and the measured maximum power value is recorded and transmitted to the control computer 40.

In the present embodiment, in order to further improve the precision and efficiency of calibration, we use an automated calibration process. The control computer automatically controls the entire calibration process through a dedicated software program. This program can automatically adjust the settings of the spectrum analyzer according to preset test parameters and monitor test data in real-time.

Firstly, the control computer 40 sets the frequency range of the spectrum analyzer 30 to the working frequency range of the phased array antenna and adjusts it to maximum signal capture mode, then the control computer 40 controls the phased array antenna 100 to begin transmitting signals. The spectrum analyzer receives and analyzes signals in real-time, and transmits the analysis results to the control computer, and the control computer controls the phased array antenna to complete the calibration.

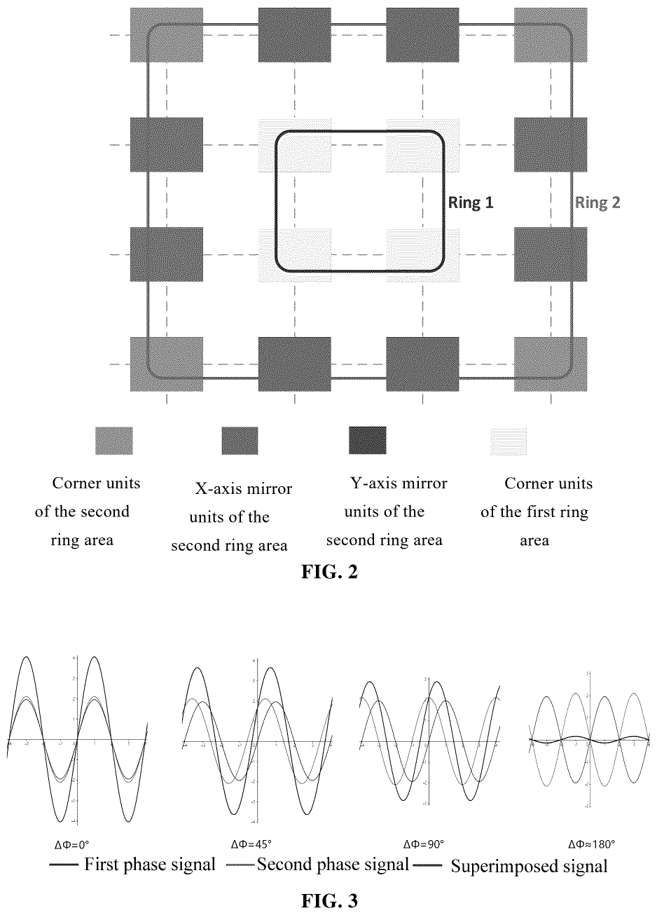

Referring to FIG. 2, the phased array antenna used in the present embodiment is a 4*4 array including 16 antenna channels. In other embodiments, the phased array antenna may also be of other specifications, such as a 6*6 array or an 8*8 array, etc.

In the present embodiment, the phased array antenna is divided into two ring areas, a first ring area Ring1 located in the middle and a second ring area Ring2 located in the periphery, wherein the second ring area includes three centrally symmetric sub-units—a corner unit, an x-axis mirror unit, and a y-axis mirror unit—and the corner unit includes four corner antenna channels located at the corner positions of the second ring area, and the x-axis mirror unit includes four x-axis antenna channels located in the x-axis direction of the second ring area, the y-axis mirror unit includes four y-axis antenna channels located in the y-axis direction of the second ring area, and the first ring area includes four corner antenna channels located at the corner positions of the first ring area.

In other embodiments, when the phased array antenna is of other specifications, such as 6*6 or 8*8, etc., the phased array antenna is divided into 3, 4, or even more ring areas, and each peripheral ring area includes a plurality of sub-units, in some implementations, one corner unit, one or more x-axis mirror units and Y-axis mirror units, wherein the number of antenna channels of the different sub-units is the same, for example, it is all four, and the phase centers of each centrally symmetric sub-unit coincide with the physical center of the phased array antenna.

In the present embodiment, calibration is performed within the corresponding corner units, within the x-axis mirror units, and within the y-axis mirror units of different ring areas of the phased array antenna, calibration is also performed between sub-units of the same ring area and between different ring areas, respectively.

In some implementations, a first calibration is performed within the corner units, within the x-axis mirror units, and within the y-axis mirror units, respectively, to obtain first amplitude control values and first phase control values for the corresponding antenna channels; a second calibration is performed between sub-units of the same ring area to obtain second amplitude control values and second phase control values for the corresponding antenna channels; a third calibration is performed between different ring areas to obtain third amplitude control values and third phase control values for the corresponding antenna channels; the first amplitude control values, the second amplitude control values, and the third amplitude control values are summed to obtain final amplitude control values, and the first phase control values, the second phase control values, and the third phase control values are summed to obtain final phase control values, and thus the calibration for the transmission of the entire phased array antenna is achieved.

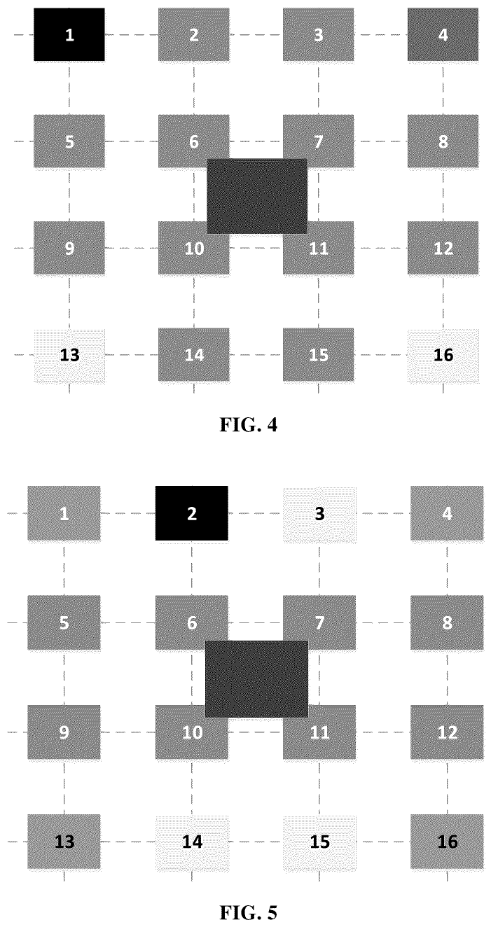

In some implementations, referring to FIG. 4, when performing the first calibration within the corner units of the second ring area, the method includes the following steps.

The first corner antenna channel 1 is opened, and other antenna channels are closed, and a specific power attenuation is set, in the present embodiment, the power attenuation is at an intermediate level, denoted as AA1, and signals are transmitted and the first corner power P1 obtained by the receiving antenna is measured; at the same time, the power attenuations described below in the present solution all are attenuations to an intermediate level, denoted as AA1, which will not be repeated below.

The second corner antenna channel 4 is opened, and other antenna channels are closed, and signals are transmitted and the attenuation is adjusted until the second corner power obtained by the receiving antenna is equal to P1, and the corresponding first amplitude control value is obtained.

The first corner antenna channel 1 and the second corner antenna channel 4 are opened, and other antenna channels are closed, and the phase of the first corner antenna channel 1 is fixed, and the phase of the second corner antenna channel 4 is adjusted, the first phase control values of the two antenna channels are recorded when power is maximum, and the calibration of the second corner antenna channel 4 is completed.

The third corner antenna channel 16 continues to be opened and other antenna channels are closed, and signals are transmitted and the attenuation is adjusted until the third corner power equals P1, and the corresponding first amplitude control value is obtained.

The first corner antenna channel 1 and the third corner antenna channel 16 are opened, and other antenna channels are closed, and the phase of the first corner antenna channel 1 is fixed, and the phase of the third corner antenna channel 16 is adjusted, the first phase control values of the two antenna channels are recorded when power is maximum, and the calibration of the third corner antenna channel 16 is completed.

The fifth corner antenna channel 13 continues to be opened and other antenna channels are closed, and signals are transmitted and the attenuation is adjusted until the fourth corner power equals P1, and the corresponding first amplitude control value is obtained.

The first corner antenna channel 1 and the fifth corner antenna channel 13 are opened, and other antenna channels are closed, and the phase of the first corner antenna channel 1 is fixed, and the phase of the fifth corner antenna channel 13 is adjusted, the first phase control values of the two antenna channels are recorded when power is maximum, and the calibration of the fifth corner antenna channel 13 is completed.

In the present embodiment, the first corner antenna channel 1 is used as the reference antenna channel to calibrate the second corner antenna channel 4, the third corner antenna channel 16, and the fifth corner antenna channel 13, respectively.

In other embodiments, the antenna channel 4, the third corner antenna channel 16, or the fifth corner antenna channel 13 may also be used as the reference antenna channel to calibrate other three corner antenna channels, and in other embodiments, the first corner antenna channel, the second corner antenna channel, the third corner antenna channel, and the fourth corner antenna channels may also be interchanged.

In some implementations, referring to FIG. 5, when performing the first calibration within the x-axis mirror units of the second ring area, the method includes the following steps.

The first x-axis antenna channel 2 is opened, and other antenna channels are closed, and a specific power attenuation is set, and signals are transmitted and the first x-axis power P2 obtained by the receiving antenna is measured; the second x-axis antenna channel 3 is opened, and other antenna channels are closed, and signals are transmitted and the attenuation is adjusted until the second x-axis power obtained by the receiving antenna equals P2, and the corresponding first amplitude control value is obtained.

The first x-axis antenna channel 2 and the second x-axis antenna channel 3 are opened, and other antenna channels are closed, and the phase of the first x-axis antenna channel is fixed, and the phase of the second x-axis antenna channel is adjusted, the first phase control values of the two antenna channels are recorded when power is maximum, and the calibration of the second x-axis antenna channel 3 is completed.

The third x-axis antenna channel 15 continues to be opened and other antenna channels are closed, and signals are transmitted and the attenuation is adjusted until the third x-axis power equals P2, and the corresponding first amplitude control value is obtained.

The first x-axis antenna channel 2 and the third x-axis antenna channel 15 are opened, and other antenna channels are closed, and the phase of the first x-axis antenna channel 2 is fixed, and the phase of the third x-axis antenna channel 15 is adjusted, the first phase control values of the two antenna channels are recorded when power is maximum, and the calibration of the third x-axis antenna channel 15 is completed.

The fourth x-axis antenna channel 14 continues to be opened and other antenna channels are closed, and signals are transmitted and the attenuation is adjusted until the fourth x-axis power equals P2, and the corresponding first amplitude control value is obtained.

The first x-axis antenna channel 2 and the fourth x-axis antenna channel 14 are opened, and other antenna channels are closed, and the phase of the first x-axis antenna channel 2 is fixed, and the phase of the fourth x-axis antenna channel 14 is adjusted, the first phase control values of the two antenna channels are recorded when power is maximum, and the calibration of the fourth x-axis antenna channel 14 is completed.

In the present embodiment, the first x-axis antenna channel 2 is used as the reference antenna channel to calibrate the second x-axis antenna channel 3, the third x-axis antenna channel 15, and the fourth x-axis antenna channel 14, respectively.

In other embodiments, the second x-axis antenna channel 3, the third x-axis antenna channel 15, or the fourth x-axis antenna channel 14 may also be used as the reference antenna channel to calibrate other three corner antenna channels, and in other embodiments, the first x-axis antenna channel, the second x-axis antenna channel, the third x-axis antenna channel, and the fourth x-axis antenna channels may also be interchanged.

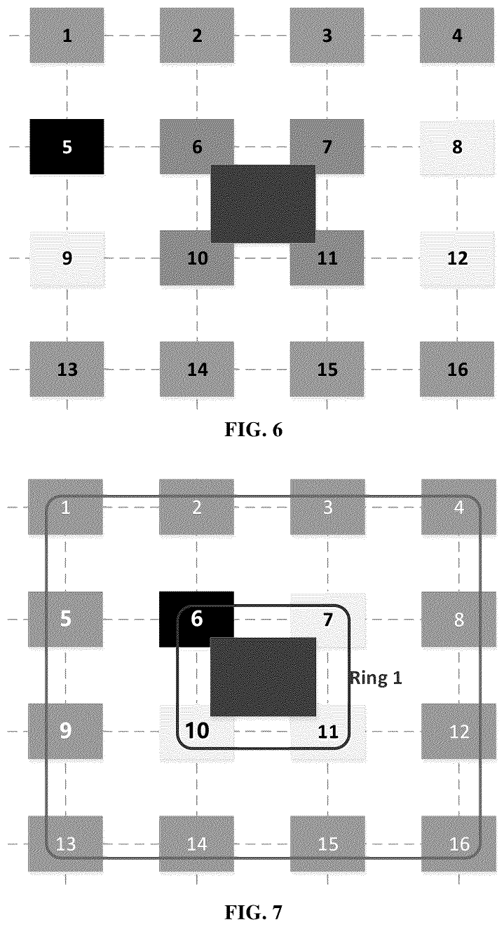

In some implementations, referring to FIG. 6, when performing the first calibration within the y-axis mirror units of the second ring area, the method includes the following steps.

The first y-axis antenna channel 5 is opened, and other antenna channels are closed, and a power attenuation is set, and signals are transmitted and the first y-axis power P3 obtained by the receiving antenna is measured.

The second y-axis antenna channel 8 is opened, and other antenna channels are closed, and signals are transmitted and the attenuation is adjusted until the second y-axis power obtained by the receiving antenna equals P3, and the corresponding first amplitude control value is obtained.

The first y-axis antenna channel 5 and the second y-axis antenna channel 8 are opened, and other antenna channels are closed, and the phase of the first y-axis antenna channel is fixed, and the phase of the second y-axis antenna channel is adjusted, the first phase control values of the two antenna channels are recorded when power is maximum, and the calibration of the second y-axis antenna channel is completed.

The third y-axis antenna channel 12 continues to be opened and other antenna channels are closed, and signals are transmitted and the attenuation is adjusted until the third y-axis power equals P3, and the corresponding first amplitude control value is obtained.

The first y-axis antenna channel 5 and the third y-axis antenna channel 12 are opened, and other antenna channels are closed, and the phase of the first y-axis antenna channel 5 is fixed, and the phase of the third y-axis antenna channel 12 is adjusted, the first phase control values of the two antenna channels are recorded when power is maximum, and the calibration of the third y-axis antenna channel 12 is completed.

The fourth y-axis antenna channel 9 continues to be opened and other antenna channels are closed, and signals are transmitted and the attenuation is adjusted until the fourth y-axis power equals P3, and the corresponding first amplitude control value is obtained.

The first y-axis antenna channel 5 and the fourth y-axis antenna channel 9 are opened, and other antenna channels are closed, and the phase of the first y-axis antenna channel 5 is fixed, and the phase of the fourth y-axis antenna channel 9 is adjusted, the first phase control values of the two antenna channels are recorded when power is maximum, and the calibration of the fourth y-axis antenna channel 9 is completed.

In the present embodiment, the first y-axis antenna channel 5 is used as the reference antenna channel to calibrate the second y-axis antenna channel 8, the third y-axis antenna channel 12, and the fourth y-axis antenna channel 9, respectively.

In other embodiments, the second y-axis antenna channel 8, the third y-axis antenna channel 12, or the fourth y-axis antenna channel 9 may also be used as the reference antenna channel to calibrate other three corner antenna channels, and in other embodiments, the first y-axis antenna channel, the second y-axis antenna channel, the third y-axis antenna channel, and the fourth y-axis antenna channels may also be interchanged.

In some implementations, referring to FIG. 7, when performing the first calibration within the corner units of the first ring area, the method includes the following steps.

The first corner antenna channel 6 is opened, and other antenna channels are closed, and a power attenuation is set, and signals are transmitted and the first corner power P4 obtained by the receiving antenna is measured.

The second corner antenna channel 7 is opened, and other antenna channels are closed, and signals are transmitted and the attenuation is adjusted until the second corner power obtained by the receiving antenna equals P4, and the corresponding first amplitude control value is obtained.

The first corner antenna channel 6 and the second corner antenna channel 7 are opened, and other antenna channels are closed, and the phase of the first corner antenna channel 6 is fixed, and the phase of the second corner antenna channel 7 is adjusted, the first phase control values of the two antenna channels are recorded when power is maximum, and the calibration of the second corner antenna channel 7 is completed.

The sixth corner antenna channel 11 continues to be opened and other antenna channels are closed, and signals are transmitted and the attenuation is adjusted until the third corner power equals P4, and the corresponding first amplitude control value is obtained.

The first corner antenna channel 6 and the sixth corner antenna channel 11 are opened, and other antenna channels are closed, and the phase of the first corner antenna channel 6 is fixed, and the phase of the sixth corner antenna channel 11 is adjusted, the first phase control values of the two antenna channels are recorded when power is maximum, and the calibration of the sixth corner antenna channel 11 is completed.

The fourth corner antenna channel 10 continues to be opened and other antenna channels are closed, and signals are transmitted and the attenuation is adjusted until the fourth corner power equals P4, and the corresponding first amplitude control value is obtained.

The first corner antenna channel 6 and the fourth corner antenna channel 10 are opened, and other antenna channels are closed, and the phase of the first corner antenna channel 6 is fixed, and the phase of the fourth corner antenna channel 10 is adjusted, the first phase control values of the two antenna channels are recorded when power is maximum, and the calibration of the fourth corner antenna channel 10 is completed.

In the present embodiment, the first corner antenna channel 6 of the first ring area is used as the reference antenna channel to calibrate the second corner antenna channel 7, the sixth corner antenna channel 11, and the fourth corner antenna channel 10, respectively.

In other embodiments, the antenna channel 7, the sixth corner antenna channel 11, or the fourth corner antenna channel 10 may also be used as the reference antenna channel to calibrate other three corner antenna channels, and in other embodiments, the first corner antenna channel, the second corner antenna channel, the third corner antenna channel, and the fourth corner antenna channels may also be interchanged.

Furthermore, in the method, when performing the second calibration between a plurality of sub-units of the second ring area Ring2, the method includes the following steps.

All corresponding antenna channels of the corner units of the second ring area are opened and other antenna channels are closed, the sub-unit power P5 obtained by the receiving antenna is measured using the spectrum analyzer.

All corresponding antenna channels of the corner units of the second ring area are closed, and all corresponding antenna channels of the x-axis mirror units of the second ring area are opened, the amplitude attenuation of all corresponding antenna channels are synchronously controlled until the measured value of the spectrum analyzer is a₁*P5, factor

$${α}_{1} = \frac{{D}^{2} + {d}_{2}^{2}}{{D}^{2} + {d}_{1}^{2}} ,$$

and D is the distance from the receiving antenna to the phase center of the phased array antenna, and d₂ is the distance from the phase center of the x-axis mirror units to the phase center of the phased array antenna; d₁ is the distance from the phase center of the corner units to the phase center of the phased array antenna, and the corresponding second amplitude control value is obtained.

All corresponding antenna channels of the corner units and the x-axis mirror units of the second ring area are synchronously opened, and the amplitudes and phases of all antenna channels in the corner units of the second ring area are maintained unchanged, and the phases of all antenna channels in the x-axis mirror units of the second ring area are synchronously transformed, the second phase control values of the two channels are recorded when power is maximum, and the calibration of the x-axis mirror units of the second ring area is completed.

In the present embodiment, the corner units of the second ring area are used as the reference units to calibrate the x-axis mirror units of the second ring area, and in other embodiments, any one of the sub-units of the same ring area may be selected as the reference unit to calibrate other sub-units.

Furthermore, in the method, when performing the third calibration between different ring areas, the method includes the following steps.

All antenna channels of the corner units of the first ring area are opened and other antenna channels are closed, the first corner unit power P6 obtained by the receiving antenna is measured using the spectrum analyzer.

All antenna channels of the corner units of the first ring area are closed, and all antenna channels of the corner units of the second ring area are opened, the amplitude attenuations of all corresponding antenna channels are synchronously controlled until the measured value of the spectrum analyzer is a₃*P6, factor

$${α}_{3} = \frac{{D}^{2} + {d}_{4}^{2}}{{D}^{2} + {d}_{1}^{2}} ,$$

and D is the distance from the receiving antenna to the phase center of the phased array antenna, and d₄ is the distance from the phase center of corner units in the second ring area to the phase center of the phased array antenna; d₁ is the distance from the phase center of the corner units in the first ring area to the phase center of the phased array antenna, and the corresponding third amplitude control value is obtained.

All corresponding antenna channels of the two corner units are synchronously opened, and the amplitudes and phases of all antenna channels of the corner units of the first ring area are maintained unchanged, and the phases of all antenna channels of the corner units of the second ring area are synchronously transformed, the third phase control values of the two channels are recorded when power is maximum, and the calibration is completed.

In the present embodiment, the corner units of the first ring area are used as the reference units to calibrate the corner units of the second ring area, and calibration of the second ring area using the first ring area is achieved. In other embodiments, any one of different ring areas may be selected as the reference unit to calibrate the other ring areas.

Finally, the first amplitude control values, the second amplitude control values, and the third amplitude control values of each antenna channel are summed to obtain final amplitude control values, and the first phase control values, the second phase control values, and the third phase control values of each antenna channel are summed to obtain final phase control values, and thus the calibration for the transmission of the entire phased array antenna is achieved.

In the present embodiment, the logical basis of the calibration process is to ensure that the antenna units at geometrically symmetric positions have zero phase difference in their path when receiving signals. This means that when signals arrive at the receiving antenna unit from different antenna channels of the phased array antenna, their arrival times are consistent, thereby ensuring phase consistency. Additionally, the phase centers of each geometrically symmetric sub-unit should coincide with the physical center of the entire phased array antenna. This design ensures that the propagation paths and phase differences of the signals in each sub-unit are precisely controlled and coordinated, thereby optimizing the performance of the entire antenna system.

Furthermore, as shown in FIG. 3, when a plurality of signals of the same frequency are superimposed in the antenna system, the amplitude of the synthesized signal will exhibit periodic changes with the changes in phase difference. This periodic change is due to interference effects caused by phase differences between different signals. By precisely controlling and adjusting the phase difference of each antenna unit, precise control of the amplitude of the synthesized signal can be achieved, so that the reception quality and transmission efficiency of the signal are improved. This calibration method is not only applicable for signal processing in static environments but also applicable for dynamically changing communication scenarios, and the stability and reliability of the antenna system under various conditions are ensured.

During implementation of the aforementioned calibration method, the effects of environmental factors on signal propagation also need to be considered. For example, the signal propagation path and phase of signals will be affected by temperature changes, humidity changes, and wind speeds, etc. Therefore, real-time monitoring of these environmental factors is required in practical operations, and the calibration parameters are dynamically adjusted according to monitoring results.

In order to achieve this object, an environmental monitoring module can be introduced, and this module can monitor environmental parameters in real-time and transmit data to the control system. The control system automatically adjusts calibration parameters according to the changes of environmental parameters to ensure the accuracy of the calibration process. For example, when the rise in temperature results in the change in the signal propagation speed, the control system will adjust the phase control parameters accordingly to compensate for the effect of temperature changes on the signal propagation path.

Additionally, to further improve the precision of calibration, a multi-frequency point calibration method can be used. Calibrating at different frequency points can ensure phase consistency of the signal throughout the entire working frequency band. During the specific operation, the above calibration process can be repeated at a plurality of predetermined frequency points, and the amplitude attenuation control and relative phase control parameters at each frequency point are recorded, and then, through interpolation or fitting methods, a calibration parameter curve for the entire frequency band is generated, so that precise calibration for any frequency point is achieved.

In one embodiment, the present disclosure further provides an electronic device including a processor, a memory, and a computer program stored in the memory and configured to be executed by the processor, and the memory is coupled with the processor, and the processor, when executing the computer program, achieves the method for calibrating the transmission of a phased array antenna with a built-in local oscillator described in the first aspect.

In summary, the calibration logic design used by the present disclosure is extremely streamlined and clear, which ensures the receiving antenna does not need to perform any movement operations during the execution of the calibration program. This design significantly improves the efficiency of calibration operations, making the entire process more efficient and convenient, particularly for phased array systems that integrate local oscillators.

The calibration technology of the present disclosure is not only applicable to phased array systems with integrated local oscillators, but can also be widely used for calibration operations of various highly integrated active phased array radars (AIP phased arrays). Therefore, the present disclosure has broad application prospects and practical application value in the field of radar system calibration.

The above embodiments are only used to illustrate the technical solutions of the present disclosure and are not intended to limit it; although the present disclosure has been described in detail referring to the aforementioned embodiments, those skilled in the art should understand that they can still modify the technical solutions described in the aforementioned various embodiments, or equivalently substitute some of the technical features; and these modifications or substitutions do not make the essences of the corresponding technical solutions depart from the spirit and scope of the technical solutions in the various embodiments of the present disclosure.

What is claimed is:

1. A method for calibrating a transmission of a phased array antenna with a built-in local oscillator, comprising:
constructing and configuring a test system, wherein a receiving antenna is located on a central axis of the phased array antenna, and the receiving antenna is connected with a spectrum analyzer;
dividing the phased array antenna according to a layout of the phased array antenna, wherein the layout of the phased array antenna is divided into a plurality of centrally symmetric ring areas according to the central axis of the phased array antenna, and each of the ring areas comprise one or more centrally symmetric sub-units, and each of the sub-units comprises a same number of antenna channels; and
transmitting signals using the phased array antenna and receiving signals by the receiving antenna, and performing amplitude and phase calibration between the antenna channels within the sub-units of the ring areas, between the sub-units of the ring areas, and between the ring areas.

2. The method for calibrating the transmission of the phased array antenna with the built-in local oscillator according to claim 1, wherein the test system comprises:
the phased array antenna;
the receiving antenna;
the spectrum analyzer; and
a control computer,
wherein the receiving antenna is connected to a signal generator, one end of the control computer is connected to the phased array antenna for configuring and controlling the antenna channels of the phased array antenna to transmit signals, another end of the control computer is connected to the signal generator, and corresponding amplitude and phase signals of the receiving antenna are obtained using the signal generator.

3. The method for calibrating the transmission of the phased array antenna with the built-in local oscillator according to claim 1, wherein:
the sub-units comprise corner units, x-axis mirror units, and y-axis mirror units;
the corner units are units of the antenna channels located at four corners of the ring areas;
the x-axis mirror units are units of the antenna channels located in an x-axis direction and centrally symmetric in the ring areas; and
the y-axis mirror units are units of the antenna channels located in a y-axis direction and centrally symmetric in the ring areas.

4. The method for calibrating the transmission of the phased array antenna with the built-in local oscillator according to claim 3, further comprising:
performing a first calibration within the corner units, within the x-axis mirror units, and within the y-axis mirror units, respectively, to obtain first amplitude control values and first phase control values for the corresponding antenna channels;
performing a second calibration between the sub-units of the same ring area to obtain second amplitude control values and second phase control values for the corresponding antenna channels; and
performing a third calibration between the ring areas to obtain third amplitude control values and third phase control values for the corresponding antenna channels,
wherein the first amplitude control values, the second amplitude control values, and the third amplitude control values are summed to obtain final amplitude control values, and the first phase control values, the second phase control values, and the third phase control values are summed to obtain final phase control values.

5. The method for calibrating the transmission of the phased array antenna with the built-in local oscillator according to claim 3, wherein when performing a first calibration within the corner units, the method further comprises:
opening a first corner antenna channel, closing other antenna channels, setting a pre-determined power attenuation, transmitting signals, and measuring a first corner power P1 of the receiving antenna;
opening a second corner antenna channel, closing other antenna channels, transmitting signals, and adjusting the power attenuation until a second corner power of the receiving antenna equals the first corner power P1, and obtaining first amplitude control values for the corresponding second corner antenna channel;
opening the first corner antenna channel and the second corner antenna channel and closing other antenna channels, fixing phase of the first corner antenna channel and adjusting phase of the second corner antenna channel, recording corresponding first phase control values of the first corner antenna channel and the second corner antenna channel when power is maximum to complete the first calibration of the second corner antenna channel; and
opening sequentially the first corner antenna channel and other corner antenna channels within the corner units simultaneously.

6. The method for calibrating the transmission of the phased array antenna with the built-in local oscillator according to claim 3, wherein when performing a first calibration within the x-axis mirror units, the method further comprises:
opening a first x-axis antenna channel, closing other antenna channels, setting a pre-determined power attenuation, transmitting signals, and measuring a first x-axis power P2 of the receiving antenna;
opening a second x-axis antenna channel, closing other antenna channels, transmitting signals, and adjusting the power attenuation until a second x-axis power of the receiving antenna equals the first x-axis power P2, and obtaining first amplitude control values for the corresponding second x-axis antenna channel;
opening the first x-axis antenna channel and the second x-axis antenna channel and closing other antenna channels, fixing phase of the first x-axis antenna channel and adjusting phase of the second x-axis antenna channel, recording first phase control values of the first x-axis antenna channel and the second x-axis antenna channel when power is maximum to complete the first calibration of the second x-axis antenna channel; and
opening sequentially the first x-axis antenna channel and other x-axis antenna channels within the x-axis mirror units simultaneously.

7. The method for calibrating the transmission of the phased array antenna with the built-in local oscillator according to claim 3, wherein when performing a first calibration within the y-axis mirror units, the method further comprises:
opening a first y-axis antenna channel, closing other antenna channels, setting a pre-determined power attenuation, transmitting signals, and measuring a first y-axis power P3 of the receiving antenna;
opening a second y-axis antenna channel, closing other antenna channels, transmitting signals and adjusting the power attenuation until a second y-axis power of the receiving antenna equals the first y-axis power P3, and obtaining first amplitude control values for the corresponding second y-axis antenna channel;
opening the first y-axis antenna channel and the second y-axis antenna channel, closing other antenna channels, fixing phase of the first y-axis antenna channel and adjusting phase of the second y-axis antenna channel, recording first phase control values of the first y-axis antenna channel and the second y-axis antenna channel when power is maximum to complete the first calibration of the second y-axis antenna channel; and
opening sequentially the first y-axis antenna channel and other y-axis antenna channels within the y-axis mirror units simultaneously.

8. The method for calibrating the transmission of the phased array antenna with the built-in local oscillator according to claim 3, wherein when performing a second calibration between sub-units of the same ring area, the method further comprises:
opening all corresponding antenna channels of a first sub-unit after a calibration of the same ring area, closing other antenna channels, transmitting signals, and measuring a sub-unit power P5 of the receiving antenna using the spectrum analyzer;
closing all corresponding antenna channels of the first sub-unit of the same ring area, opening all corresponding antenna channels of any one of other sub-units after the calibration;
synchronously controlling amplitude attenuation of all corresponding antenna channels until a measured value of the spectrum analyzer is a₁*P5, wherein factor
$${α}_{1} = \frac{{D}^{2} + {d}_{2}^{2}}{{D}^{2} + {d}_{1}^{2}} ,$$
D is a distance from the receiving antenna to a phase center of the phased array antenna, d₂ is a distance from a phase center of the other sub-units to the phase center of the phased array antenna, and d₁ is a distance from a phase center of the first sub-unit of the same ring area to the phase center of the phased array antenna, and obtaining corresponding second amplitude control values;
synchronously opening all corresponding antenna channels of the above sub-unit after amplitude calibration, maintaining amplitudes and phases of all antenna channels of a second sub-unit unchanged, synchronously transforming the phases of all antenna channels in a third sub-unit, recording second phase control values of the third sub-unit when power is maximum to complete the calibration for the third sub-unit of the same ring area; and
opening sequentially all corresponding antenna channels of the first sub-unit of the same ring area and all corresponding antenna channels of the sub-units of the same ring area simultaneously.

9. The method for calibrating the transmission of the phased array antenna with the built-in local oscillator according to claim 3, wherein when performing a third calibration between the ring areas, the method further comprises:
opening all antenna channels of a first sub-unit of a first ring area after the calibration, closing other antenna channels, transmitting signals and measuring a power P6 of the first sub-unit of the first ring area obtained by the receiving antenna using the spectrum analyzer;
closing all antenna channels of the first sub-unit of the first ring area, opening all antenna channels of a second sub-unit of a second ring area after the calibration;
synchronously controlling amplitude attenuation of all corresponding antenna channels until a measured value of the spectrum analyzer is a₃*P6, wherein factor
$${α}_{3} = \frac{{D}^{2} + {d}_{4}^{2}}{{D}^{2} + {d}_{1}^{2}} ,$$
D is a distance from the receiving antenna to a phase center of the phased array antenna, d₄ is a distance from a phase center of the corresponding sub-unit of the corresponding second ring area to the phase center of the phased array antenna, d₁ is a distance from a phase center of the corresponding sub-unit in the first ring area to the phase center of the phased array antenna, and obtaining third amplitude control values of a sub-unit of the corresponding second ring area;
synchronously opening all the above antenna channels after amplitude calibration, maintaining amplitudes and phases of all antenna channels of a third sub-unit of the first ring area unchanged, synchronously transforming the phases of all antenna channels of a fourth sub-unit of a fourth ring area, recording third phase control values of the fourth sub-unit of the corresponding fourth ring area when power is maximum to complete the third calibration for the corresponding fourth ring areas; and
opening sequentially all corresponding antenna channels of the first sub-unit of the first ring area and all corresponding antenna channels of the sub-units of other ring areas simultaneously.

10. The method for calibrating the transmission of the phased array antenna with the built-in local oscillator according to claim 1, wherein a phase center of each centrally symmetric sub-unit coincides with a physical center of the phased array antenna.

11. The method for calibrating the transmission of the phased array antenna with the built-in local oscillator according to claim 1, further comprising:
using a multi-frequency point calibration method to perform multiple calibrations at different frequency points.

12. An electronic device, comprising:
a processor;
a memory coupled to the processor; and
a computer program stored in the memory and configured to be executed by the processor, wherein the processor, when executing the computer program, is configured to perform a method for calibrating a transmission of a phased array antenna, wherein the method comprises:
constructing and configuring a test system, wherein a receiving antenna is located on a central axis of the phased array antenna, and the receiving antenna is connected with a spectrum analyzer;
dividing the phased array antenna according to a layout of the phased array antenna, wherein the layout of the phased array antenna is divided into a plurality of centrally symmetric ring areas according to the central axis of the phased array antenna, and each of the ring areas comprise one or more centrally symmetric sub-units, and each of the sub-units comprises a same number of antenna channels; and
transmitting signals using the phased array antenna and receiving signals by the receiving antenna, and performing amplitude and phase calibration between the antenna channels within the sub-units of the ring areas, between the sub-units of the ring areas, and between the ring areas.

13. The electronic device according to claim 12, wherein the test system comprises:
the phased array antenna;
the receiving antenna;
the spectrum analyzer; and
a control computer,
wherein the receiving antenna is connected to a signal generator, one end of the control computer is connected to the phased array antenna for configuring and controlling the antenna channels of the phased array antenna to transmit signals, another end of the control computer is connected to the signal generator, and corresponding amplitude and phase signals of the receiving antenna are obtained using the signal generator.

14. The electronic device according to claim 12, wherein:
the sub-units comprise corner units, x-axis mirror units, and y-axis mirror units;
the corner units are units of the antenna channels located at four corners of the ring areas;
the x-axis mirror units are units of the antenna channels located in an x-axis direction and centrally symmetric in the ring areas; and
the y-axis mirror units are units of the antenna channels located in a y-axis direction and centrally symmetric in the ring areas.

15. The electronic device according to claim 14, wherein the method further comprises:
performing a first calibration within the corner units, within the x-axis mirror units, and within the y-axis mirror units, respectively, to obtain first amplitude control values and first phase control values for the corresponding antenna channels;
performing a second calibration between the sub-units of the same ring area to obtain second amplitude control values and second phase control values for the corresponding antenna channels; and
performing a third calibration between the ring areas to obtain third amplitude control values and third phase control values for the corresponding antenna channels,
wherein the first amplitude control values, the second amplitude control values, and the third amplitude control values are summed to obtain final amplitude control values, and the first phase control values, the second phase control values, and the third phase control values are summed to obtain final phase control values.

16. The electronic device according to claim 14, wherein when performing a first calibration within the corner units, the method further comprises:
opening a first corner antenna channel, closing other antenna channels, setting a pre-determined power attenuation, transmitting signals, and measuring a first corner power P1 of the receiving antenna;
opening a second corner antenna channel, closing other antenna channels, transmitting signals, and adjusting the power attenuation until a second corner power of the receiving antenna equals the first corner power P1, and obtaining first amplitude control values for the corresponding second corner antenna channel;
opening the first corner antenna channel and the second corner antenna channel and closing other antenna channels, fixing phase of the first corner antenna channel and adjusting phase of the second corner antenna channel, recording corresponding first phase control values of the first corner antenna channel and the second corner antenna channel when power is maximum to complete the first calibration of the second corner antenna channel; and
opening sequentially the first corner antenna channel and other corner antenna channels within the corner units simultaneously.

17. The electronic device according to claim 14, wherein when performing a first calibration within the x-axis mirror units, the method further comprises:
opening a first x-axis antenna channel, closing other antenna channels, setting a pre-determined power attenuation, transmitting signals and measuring a first x-axis power P2 of the receiving antenna;
opening a second x-axis antenna channel, closing other antenna channels, transmitting signals and adjusting the power attenuation until a second x-axis power of the receiving antenna equals the first x-axis power P2, and obtaining first amplitude control values for the corresponding second x-axis antenna channel;
opening the first x-axis antenna channel and the second x-axis antenna channel and closing other antenna channels, fixing phase of the first x-axis antenna channel and adjusting phase of the second x-axis antenna channel, recording first phase control values of the first x-axis antenna channel and the second x-axis antenna channel when power is maximum to complete the first calibration of the second x-axis antenna channel; and
opening sequentially the first x-axis antenna channel and other x-axis antenna channels within the x-axis mirror units simultaneously.

18. The electronic device according to claim 14, wherein when performing a first calibration within the y-axis mirror units, the method further comprises:
opening a first y-axis antenna channel, closing other antenna channels, setting a pre-determined power attenuation, transmitting signals, and measuring a first y-axis power P3 of the receiving antenna;
opening a second y-axis antenna channel, closing other antenna channels, transmitting signals and adjusting the power attenuation until a second y-axis power of the receiving antenna equals the first y-axis power P3, and obtaining first amplitude control values for the corresponding second y-axis antenna channel;
opening the first y-axis antenna channel and the second y-axis antenna channel, closing other antenna channels, fixing phase of the first y-axis antenna channel and adjusting phase of the second y-axis antenna channel, recording first phase control values of the first y-axis antenna channel and the second y-axis antenna channel when power is maximum to complete the first calibration of the second y-axis antenna channel; and
opening sequentially the first y-axis antenna channel and other y-axis antenna channels within the y-axis mirror units simultaneously.

19. The electronic device according to claim 14, wherein when performing a second calibration between sub-units of the same ring area, the method further comprises:
opening all corresponding antenna channels of a first sub-unit after a calibration of the same ring area, closing other antenna channels, transmitting signals, and measuring a sub-unit power P5 of the receiving antenna using the spectrum analyzer;
closing all corresponding antenna channels of the first sub-unit of the same ring area, opening all corresponding antenna channels of any one of other sub-units after the calibration;
synchronously controlling amplitude attenuation of all corresponding antenna channels until a measured value of the spectrum analyzer is a₁*P5, wherein factor
$${α}_{1} = \frac{{D}^{2} + {d}_{2}^{2}}{{D}^{2} + {d}_{1}^{2}} ,$$
D is a distance from the receiving antenna to a phase center of the phased array antenna, d₂ is a distance from a phase center of the other sub-units to the phase center of the phased array antenna, and d₁ is a distance from a phase center of the first sub-unit of the same ring area to the phase center of the phased array antenna, and obtaining corresponding second amplitude control values;
synchronously opening all corresponding antenna channels of the above sub-unit after an amplitude calibration, maintaining amplitudes and phases of all antenna channels of a second sub-unit unchanged, synchronously transforming the phases of all antenna channels in a third sub-unit, recording second phase control values of the third sub-unit when power is maximum to complete the calibration for the third sub-unit of the same ring area; and
opening sequentially all corresponding antenna channels of the first sub-unit of the same ring area and all corresponding antenna channels of the sub-units of the same ring area simultaneously.

20. The electronic device according to claim 14, wherein when performing a third calibration between the ring areas, the method further comprises:
opening all antenna channels of a first sub-unit of a first ring area after a calibration, closing other antenna channels, transmitting signals and measuring a power P6 of the first sub-unit of the first ring area obtained by the receiving antenna using the spectrum analyzer;
closing all antenna channels of the first sub-unit of the first ring area, opening all antenna channels of a second sub-unit of a second ring area after the calibration;
synchronously controlling amplitude attenuation of all corresponding antenna channels until a measured value of the spectrum analyzer is a₃*P6, wherein factor
$${α}_{3} = \frac{{D}^{2} + {d}_{4}^{2}}{{D}^{2} + {d}_{1}^{2}} ,$$
D is a distance from the receiving antenna to a phase center of the phased array antenna, d₄ is a distance from a phase center of the corresponding sub-unit of the corresponding second ring area to the phase center of the phased array antenna, d₁ is a distance from a phase center of the corresponding sub-unit in the first ring area to the phase center of the phased array antenna, and obtaining third amplitude control values of a sub-unit of the corresponding second ring area;
synchronously opening all the above antenna channels after amplitude calibration, maintaining amplitudes and phases of all antenna channels of a third sub-unit of the first ring area unchanged, synchronously transforming the phases of all antenna channels of a fourth sub-unit of a fourth ring area, recording third phase control values of the fourth sub-unit of the corresponding fourth ring area when power is maximum to complete the third calibration for the corresponding fourth ring areas; and
opening sequentially all corresponding antenna channels of the first sub-unit of the first ring area and all corresponding antenna channels of the sub-units of other ring areas simultaneously.
